(19) United States
(12) Patent Application Publication
(10) Pub. No.: US 2002/0152198 A1
(43) Pub. Date: Oct. 17, 2002

(54) Method for the operation of an automatic telephone information system

(76) Inventors: Henrik Hodam, Aachen (DE); NiIs Lenke, Rheinbach (DE)

Correspondence Address: U.S. Philips Corporation, 580 White Plains Road, Tarrytown, NY, 10591, US

(21) Appl. No.: 10/117,853

(22) Filed: Apr. 8, 2002

(30) Foreign Application Priority Data
Apr. 11, 2001 (DE) 10118038.1

(51) Int. Cl. G06F 7/00

(52) U.S. Cl. 707/1

(57) ABSTRACT

A method is described for the operation of an automatic telephone information system in which a user transmits the search parameters to the system by means of a terminal (1) connected with the system. The system then searches from the search parameters for the subscriber data (TD) of a subscriber sought by the user and stored in the system database (3) and outputs corresponding subscriber data (TD) found in the database (3) to the user. A priority value (P) which can be selected by the subscriber concerned from a multiplicity of priority values is allocated to each of the subscriber data records (TDS) of each subscriber stored in the database (3).

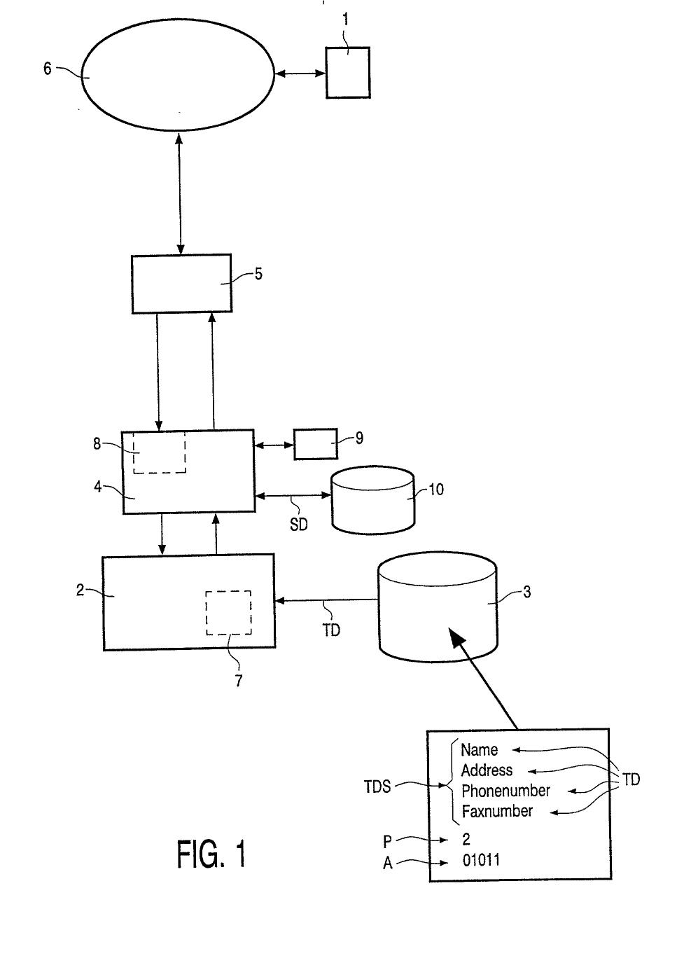

The order of output of subscriber data (TD) of the subscribers found in the database (3) depends on the priority values (P) allocated to the subscriber data records (TDS) concerned. In addition a corresponding automatic telephone information system is claimed.

The invention relates to a method for the operation of an automatic telephone information system in which subscribers whose subscriber data stored in the system database corresponds to the search parameters are sought from search parameters given to the system via a terminal by a user and in which method subscriber data of at least one subscriber found are output to the user. In addition, the invention relates to a corresponding telephone information system. The search parameters are various search criteria e.g. the name of a subscriber or sector sought, a special area or location or associated search concepts e.g. “Maier”, “doctors”, “homeopathy”, “Munich”. Subscriber data is usually the telephone number but also possibly the address or other information which enables the user to make contact with the subscriber sought.

Such telephone information systems are already known in practice. Problems always arise here when, using the search parameters, a multiplicity of subscribers are found whose subscriber data correspond to the search parameters and a further refinement or restriction of the search is not sensible or possible, for example because the user concerned does not know any more restrictive parameters. In an enquiry to a telephone sector information system this often arises inter alia when searching simply for a supplier within a particular sector e.g. a baker's shop, a pizza service, a doctor or a solicitor within a particular town. In many cases further restriction of this sector is not possible or sensible so under certain circumstances more than a hundred suppliers can be found which must be output in order to the user. Under some circumstances the user will spend time listening at least to a great part of the supplier data in order then to decide, for example by means of distance from the supplier, which supplier he requires. Often however the user does not have time for this and he interrupts the output after a short time so that only the first suppliers named are actually output to the user concerned. Therefore it is in the interests of these suppliers to be output as early as possible. The same problem however occurs with a “simple” telephone information system, for example for business and private entries, if the user asks for a surname or company name which occurs relatively frequently. In these cases in large cities etc. it can be expected that a very large number of subscribers who fulfil these search criteria will be found. Even when refined to extended company names or first names, if these extensions or first names are also equally common, still a high number of hits can occur. Further refinement of the search is then only possible if the user concerned knows more precise data for example the road or even the complete address of the subscriber sought. This is however not always the case. If the user wishes to reach a particular subscriber, this can lead to him listening to the output of all subscribers found and then calling the individual subscribers in turn. In this case it can be advantageous in particular for private individuals to be named as close as possible to the end of a list in order to avoid nuisance enquiries from users who are actually searching for another subscriber with the same name. Whereas in an output of suppliers of a particular sector, in which the distance to the user could be essential, it is sensible to arrange the output of subscriber data according to the distance from the subscriber and thus achieve an output favorable and comfortable for the user, such sorting in other cases is not particularly useful.

It is therefore the object of the invention to improve a method for the operation of an automatic telephone information system or a corresponding telephone information system in an economic and simple manner so that the output of subscriber data takes place in a manner which is adaptable to the interests of the subscriber concerned.

This object is achieved by a method as claimed in claim 1 or an automatic telephone information system as claimed in claim 8. According to the invention, allocated to each subscriber data record for each subscriber stored in a database is a priority value which can be selected by the subscriber concerned in advance from a multiplicity of priority values. This means that the information system operator establishes for example priority categories or priority values and on inclusion of his data record in the database, the subscriber chooses which priority value belongs to this subscriber record.

Several subscriber data records per subscriber are possible. For example a subscriber who is recorded both as a private individual and as a supplier under his private name in the database is allocated two different subscriber data records, where again different priority values are allocated to the two data records.

By means of the priority values, on output of subscriber data, the order is defined in which the subscriber data of the subscribers found are output to the user. By selecting a suitable priority category, a subscriber can influence whether he should be named to the user concerned as early as possible or only very late within a list of several subscribers found.

For a commercial supplier it is to be assumed that he wishes to be named with as high a priority as possible. To prevent each supplier selecting the same high priority value, it is therefore sensible if the selection of priority value is cost-dependent, i.e. for example for inclusion of a subscriber data record in the database with a high priority, the supplier must pay the operator of the telephone information system a higher price than if a lower priority is selected, as depending on the level of priority value on average the subscriber data of this supplier will be given to users more frequently than subscriber data of suppliers who have selected a lower priority value.

For private entries however it can be sensible to make the selection independent of costs in order here to exploit the varying communication tolerance or “nuisance threshold” of the individual subscribers in order to achieve as even as possible a distribution of the various subscribers to the different priority categories.

An automatic telephone information system according to the invention requires, as well as the database in which the subscriber data records are stored, means for entering search parameters by the user, a search device for searching for subscribers as a function of subscriber data and the search parameters, and means for output of subscriber data for the subscribers found. In addition it is necessary for the subscriber data records stored in the database to be allocated a priority value. In the database for each entry an additional priority category information must be contained i.e. the priority value. In addition a sorting device is required to sort the subscriber data of the subscribers found as a function of the priority values concerned before output to the user.

Preferably the search parameters are given or the automatic telephone information system controlled by the user via a user dialog system. This user dialog system should have automatic speech recognition which analyses the user's speech received via the telephone connection and recognizes this, and means for output of input requests and/or subscriber data of the subscribers found. This can be any speech output device e.g. a speech synthesizer device (speech synthesizer) which from fragments compiles a required word or sentence, or also automatically selectable prestored replies in a database. Such a user dialog system can for example be implemented in the form of software on a server which contains a corresponding suitable menu guide and which for example contains speech recognition and speech output facilities also in the form of software e.g. as sub-routines, or which triggers the units concerned such as speech recognition device or speech output device. Control can also take place, in addition to spoken commands, by the user pressing buttons on the terminal keypad, for example the DTMF keys (dual tone multi frequency) normal on modem telephones. A combination of control via key pressing and commands is also possible.

In cases where several subscribers with the same priority value are found, the output of subscriber data of the subscribers found with the same priority value can take place in alphabetical order. In the case of entries of subscribers with the same name however this is not possible. Here data could for example be output in sorted increasing or decreasing order of telephone numbers.

In particular in cases where the priority value depends on the entry costs, it is however more sensible to arrange the sorting of subscribers with the same priority value in the form that allows as even as possible a weighting of the individual subscribers within the same priority category. This could be achieved for example if the output were given as a function of the distance determined between the subscriber's location and the current location of the user, as it is to be assumed that users will be calling from various locations. Another advantageous possibility is to apply the random principle on output or for example sort following a rotating system as a function of previously output sequences of the same or similar enquiries. In this case at least a number of previous enquiries must be stored in a corresponding memory device and on an enquiry which, via the search parameters, gives several suppliers within a priority, the output sequence of the last enquiries with the same search parameters are retrieved in this database to ensure that now a different order is selected from that of the previous enquiries.

A further disadvantage of the automatic telephone information systems known to date is that usually only the telephone number of the subscriber concerned is given. Also the output is always given in the same form e.g. with the same type of speech output, for example by means of a speech synthesizer. In a particularly preferred embodiment of the method according to the invention therefore an acoustic output of subscriber data takes place by means of the user's terminal in a form prespecified by the subscriber concerned via a speech synthesizer device, or alternatively or additionally by output of a sound file stored in a memory device.

The subscriber concerned, for example a special supplier, can then select in advance how his subscriber data should be output to a user i.e. a potential customer. On output of a previously recorded sound file the subscriber concerned can output any text or any sound, for example background music. The supplier thus has the facility of placing a type of acoustic advertisement within the telephone information system. As well as suitable music, for example a standard speaker or prominent speaker can be selected who speaks a desired text with essential information, or an own speech recording is made with the required text. Also the scope of information given by the supplier can be varied. Thus the supplier concerned can as well as the telephone number for example give addresses, opening times or special offers. As the output of such sound files causes a higher acceptance in the user than the mechanical output by means of speech synthesis, but on the other hand the storage of sound files requires a greater memory capacity, it is suitable if the choice of output of sound files is dependent on the payment from the subscriber concerned to the operator of the telephone information system, where the amount to be paid can also depend on the length of the sound file.

The optional acoustic output of subscriber data by means of speech synthesis or by playing a sound file can be achieved for example if within a subscriber data record or allocated to a subscriber data record is a corresponding output code parameter which specifies the output type. On output of subscriber data then for example within the dialog system these output code parameters can be checked. As a function of these parameters then either the subscriber data given are converted into spoken information for the user by means of the speech synthesizer or instead a sound file is retrieved from the database and played. This output code parameter can in a preferred embodiment be the address under which the sound file is located in the database. By a defined address for example “00000” or “11111”, the dialog system is told that conversion of the subscriber data given into spoken information by means of the speech synthesizer is required. Alternatively it is naturally also possible to integrate the sound file directly into the database for subscriber data records and attach this to the relevant subscriber data records and transmit the entire data to the dialog system which then, if no sound file is attached, converts the subscriber data sound to be output into speech information by means of the speech synthesizer and otherwise only replays the sound file. The former method however has the advantage that the database with subscriber data records can be kept relatively small and hence searching of the database is faster.

In a further preferred embodiment of the method according to the invention there is also the possibility, for example by means of “call transfer”, on output of subscriber data, of connecting the user optionally i.e. at the user's wish directly to the dialog system allocated to the subscriber concerned to request further information. Similarly immediate connection of the subscriber directly to the subscriber's connection by means of corresponding call transfer system is also possible.

The possibility of call transfer and the information required can also be stored in the subscriber records themselves or a corresponding marker can be used which indicates the possibility of call transfer to the subscriber's connection or a separate subscriber dialog system and/or gives an address under which the necessary information for call transfer is stored.

The invention will be further described with reference to examples of embodiment shown in the drawings to which however the invention is not restricted. The features shown below and the features already described above can be essential to the invention not only in the combinations cited but also individually or in other combinations.

The sole FIGURE shows a diagrammatic arrangement of an example of embodiment of the telephone information system according to the invention which can be accessed via terminal 1 of a user via a telephone network 6 and a telephone connection point 5 of the telephone information system. The terminal 1 of the user is usually a conventional fixed network or mobile phone. It can however also be any other device with the respective telephone function, for example a PC or organizer or the like.

The telephone information system first has, for communication with the user by means of speech, a user dialog system 4 in which is integrated a speech recognition device 8. By means of this speech recognition device 8 the speech information from the user passed on by the telephone network connection point 5, for example control commands or search parameters, is converted into machine-legible information or text information. This data is then passed to a search device 2 for example a server equipped with suitable software. The search device 2 then searches from a database 3, in which are stored the various subscriber data records TDS of the various subscribers, those subscribers whose subscriber data records TDS correspond to the search parameters preset by the user i.e. in which the corresponding subscriber data have the necessary correlation to the search parameters.

Also attached to the subscriber data record TDS in database 3 is a priority value P and an output code parameter A. The priority value P shows with which priority the subscriber data TD of the subscriber should be output when several subscribers are found using the preset search parameter by the user. The output code parameter A states in which form the subscriber data TD for the subscriber concerned should be output.

To sort the subscriber data for output to the user the search device 2 has a sorting facility 7 which sorts the subscriber data TD using priority values P. If several of the subscribers found have the same priority value P, sorting takes place within the subscribers with the same priority value P following a random principle. The sorting device 7 can also be installed on the computer as software containing a search facility 2. Here this can be a subroutine within the search software.

The subscriber data TD but also the input requests, for example a request to enter control commands or search parameters, are again output via the dialog system 4 which generates suitable speech sequences which are output via the telephone network connection point 5 and the telephone network 6 to the terminal 1 of the user.

The user dialog system 4 is here connected with a speech synthesizer 9 which from speech fragments converts the machine-legible information or text information to be output into speech information.

Also the user dialog system 4 is connected with a database 10 which contains sound files SD for various subscribers. On output of subscriber data TD the search device 2 transmits to the dialog system 4 together with the subscriber data TD the associated output code parameter A, which can for example be an address under which the associated sound files SD can be found in database 10. Using these addresses the corresponding sound files SD are retrieved from the database 10 and replayed via the telephone connection point 5, the telephone network 6 and the terminal 1 to the enquiring user. Where no sound file can be found under the address concerned or for example if a preset address is given e.g. “00000”, or even if there is no output code parameter A, the subscriber data TD transmitted, for example name and telephone number, are converted by means of the speech synthesizer 9 into speech information for output to the user.

Where a sound file SD is to be played, in principle it is sufficient if the search device 2 merely transmits the output code parameter A containing the address of the sound file in the database 10. Transmission of the other subscriber data TD contained in the database 3 such as name and address and telephone number is then not necessary as this information will be packed in the sound file SD.

As well as the search device 2 and sorting device 7, the user dialog system 4 with speech recognition device 8 and speech synthesizer 9 and the associated databases 3 and can be largely integrated as software within a single server.

The method has particular benefits for companies who thus obtain the facility of compiling their individual offer within a telephone sector information system and in particular adapting the output of their subscriber data to potential customers through the telephone information system to the company concept. The operator of such a telephone information system can offer subscribers a wider range of services. This also offers the facility of obtaining extra payments according to the additional service or achieving a distinction from competitors by individualizing the telephone information system.

1. A method for the operation of an automatic telephone information system in which, using search parameters transmitted to the system by means a terminal (1) of a user, subscribers are sought whose subscriber data (TD) stored in the system database (3) corresponds to the search parameters and in which the subscriber data (TD) of at least one subscriber found are output to the user, characterized in that allocated to each subscriber data record (TDS) of each subscriber stored in the database (3) is a priority value (P) which can be selected by the subscriber concerned from the multiplicity of priority values, and the order of output to the user of subscriber data (TD) of the subscribers found depends on the priority values (P) allocated to the subscribers concerned.

2. A method as claimed in claim 1, characterized in that search parameters are entered and/or the automatic telephone information system controlled by the user by means of a user dialog system (4) with automatic speech recognition device (8) and with means (9, 10) for output of input requests and/or subscriber data (TD) of the subscribers found.

3. A method as claimed in claim 1 or 2, characterized in that the sequence of output of the subscriber data (TD) of subscribers found with the same priority value (P) depends on a distance measurement determined between the subscriber location and the current user location.

4. A method as claimed in claim 1 or 2, characterized in that the sequence of output of subscriber data (TD) of subscribers found with the same priority value (P) is based on a random principle and/or depends on output sequences of previous enquiries to the telephone information system.

5. A method as claimed in any of claims 1 to 4, characterized in that an acoustic output of subscriber data takes place by means of the user's terminal in a form preset by the subscriber concerned using a speech synthesizer device (9) and/or by output of a sound file (SD) stored in a memory device (10).

6. A method as claimed in claim 5, characterized in that allocated to the subscriber data records (TDS) in the database (3) is an output code parameter (A) which specifies whether the acoustic output of subscriber data takes place using the speech synthesizer device (9) and/or by output of a sound file (SD) stored in the memory device (10).

7. A method as claimed in any of claims 1 to 6, characterized in that the user on output of subscriber data is connected directly with the dialog system allocated to the subscriber concerned to request further information.

8. An automatic telephone information system which for use is connected with a terminal (1) of a user, with a database (3) in which are stored subscriber data records (TDS) of a multiplicity of subscribers, with means (1, 6, 5, 4, 8) for entering search parameters by the user, with a search device (2) for searching for subscribers whose subscriber data (TD) correspond to the search parameters, and with means (4, 10, 9, 5, 6, 1) for output of subscriber data (TD) of at least one subscriber found, characterized by the priority values (P) allocated to the subscriber data records (TDS) stored in the database (3) and a sorting device (7) in order to sort the subscriber data (TD) of the subscribers found as a function of the associated priority values (P) for output to the user.

9. A system as claimed in claim 8, characterized by a user dialog system (4) for the user to control the automatic telephone information system and enter search parameters, with an automatic speech recognition device (8) and with means (9, 10) for output of input requests and/or subscriber data (TD) of the subscribers found.

10. A system as claimed in claim 8 or 9, characterized by a speech synthesis device (9) for output of subscriber data (TD) and a memory device (10) for storage of sound files (SD) allocated to various subscribers which contains subscriber data of the subscriber concerned.

11. A system as claimed in any of claims 8 to 10, characterized by means to connect the user on output of subscriber data optionally directly with the dialog system allocated to the subscriber concerned to request further information.
